(19) United States
(12) Patent Application Publication
(10) Pub. No.: US 2025/0296000 A1
(43) Pub. Date: Sep. 25, 2025

(54) AUTOMATED GAME DATA USING AI RECOGNITION

(71) Applicant: Sony Interactive Entertainment Inc., Tokyo (JP)

(72) Inventor: Derek Andrew Parker, Alameda, CA (US)

(21) Appl. No.: 18/610,807

(22) Filed: Mar. 20, 2024

(51) Int. Cl. A63F 13/67; A63F 13/497; A63F 13/86; G06F 16/738

(52) U.S. Cl. CPC A63F 13/67; A63F 13/497; A63F 13/86; G06F 16/738

(57) ABSTRACT

A method implemented by at least one computing device is provided for verified recognition for a video game, including: executing a session of a video game, wherein the execution of the session generates gameplay video, and wherein the execution of the session further includes execution of instrumentation of the video game that outputs game event data; using an artificial intelligence (AI) recognition model to analyze the gameplay video and generate an AI-generated description of gameplay events occurring in the gameplay video; using the game event data to verify the AI-generated description; storing the verified AI-generated description to a storage device.

### BACKGROUND OF THE INVENTION

The video game industry has seen many changes over the years. As technology advances, video games continue to achieve greater immersion through sophisticated graphics, realistic sounds, engaging soundtracks, haptics, etc. Players are able to enjoy immersive gaming experiences in which they participate and engage in virtual environments, and new ways of interaction are sought. Furthermore, players may stream video of their gameplay for spectating by spectators, enabling others to share in the gameplay experience.

It is in this context that implementations of the disclosure arise.

### SUMMARY OF THE INVENTION

Implementations of the present disclosure include methods, systems and devices for providing automated game data using artificial intelligence (AI) recognition.

In some implementations, a method implemented by at least one computing device is provided for verified recognition for a video game, including: executing a session of a video game, wherein the execution of the session generates gameplay video, and wherein the execution of the session further includes execution of instrumentation of the video game that outputs game event data; using an artificial intelligence (AI) recognition model to analyze the gameplay video and generate an AI-generated description of gameplay events occurring in the gameplay video; using the game event data to verify the AI-generated description; storing the verified AI-generated description to a storage device.

In some implementations, using the AI recognition model to analyze the gameplay video and using the game event data to verify the AI-generated description occurs in substantial real-time concurrent with the execution of the session of the video game.

In some implementations, using the game event data to verify the AI-generated description includes determining a similarity between the AI-generated description and the game event data for corresponding timepoints within the gameplay video.

In some implementations, determining the similarity uses a similarity model that maps terms generated by the instrumentation to terms generated by the AI recognition model.

In some implementations, the game event data identifies one or more of characters, objects, actions, movements, locations, scenes, and settings of the video game.

In some implementations, the AI-generated description consists of text data.

In some implementations, the method further includes: using the verified AI-generated description to search a library of pre-recorded gameplay videos; surfacing through a user interface during the execution of the video game, one or more of the pre-recorded gameplay videos identified by the search.

In some implementations, the method further includes: retrieving the AI-generated description from the storage device; using a generative AI model to generate a replay video based on the AI-generated description; presenting the replay video on a display device.

In some implementations, the method further includes: retrieving the AI-generated description from the storage device; using a generative AI model to generate state data based on the AI-generated description; applying the state data to execute a second session of the video game, so that the execution of the second session is configured to generate a replay video that is similar to the gameplay video.

In some implementations, the execution of the second session is further configured to receive player input to drive the execution of the second session, enabling interactive gameplay of a scene depicted in the gameplay video.

Other aspects and advantages of the disclosure will become apparent from the following detailed description, taken in conjunction with the accompanying drawings, illustrating by way of example the principles of the disclosure.

### BRIEF DESCRIPTION OF DRAWINGS

The disclosure may be better understood by reference to the following description taken in conjunction with the accompanying drawings in which:

FIG. 1 illustrates a process for determining the contents of gameplay video, in accordance with implementations of the disclosure.

FIG. 2 illustrates a process for using an AI-generated description of gameplay to surface related videos, in accordance with implementations of the disclosure.

FIG. 3 conceptually illustrates bookmarking of gameplay video and sharing of bookmarked sections, in accordance with implementations of the disclosure.

FIG. 4 conceptually illustrates a process for re-generating a gameplay video that is configured to be similar to an original gameplay video, in accordance with implementations of the disclosure.

FIG. 5 conceptually illustrates a process for using generative AI to recreate game state data capable of being run by an instance of a video game, in accordance with implementations of the disclosure.

FIG. 6 illustrates components of an example device 600 that can be used to perform aspects of the various embodiments of the present disclosure.

### DETAILED DESCRIPTION OF THE INVENTION

Modern video games involve the execution of complex software in order to generate high fidelity video and audio. It is useful to understand what is occurring in the gameplay of a given session of a video game in order to provide game-related services, such as providing access to related videos to aid the player. One technique for developing such an understanding is to obtain data through specific instrumentation that is included in the video game code. However, the volume of data that may be output and transmitted by such instrumentation can be very costly to handle, both in terms of network bandwidth when transmitted over a network (e.g. the Internet), and in terms of resources required to process such a volume of data in order to determine what is occurring in the session of the video game. Furthermore, these issues are multiplied when handling such data at scale in the case of a centralized system servicing many players, as this can mean simultaneous handling of hundreds of thousands of data streams requiring extensive networking and processing resources.

In view of these problems, implementations of the present disclosure provide systems and methods that leverage artificial intelligence (AI) (or machine learning) to automatically analyze gameplay to determine relevant objects, states, activity, etc. This enables generation of a light-weight description of the gameplay that can be used for various purposes, such as to surface granular game help or enable later replay of the game scene.

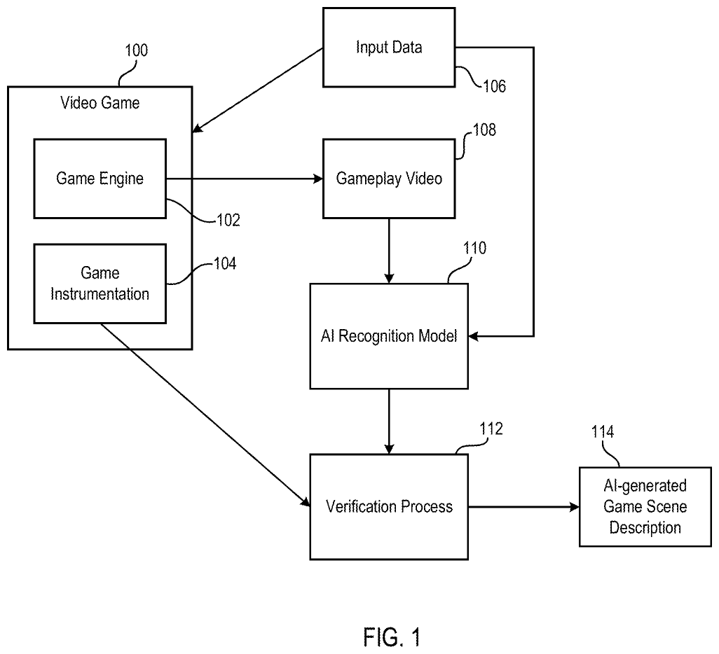

FIG. 1 illustrates a process for determining the contents of gameplay video, in accordance with implementations of the disclosure.

A session of a video game 100 is executed in order to provide interactive gameplay of the video game to a player. The video game 100 receives input data 106 (e.g. controller device inputs, motion inputs, audio input, video input, etc.) and processes the input data as it continually updates the game state of the video game. The execution of the video game 100 entails execution of a game engine 102 to render gameplay video 108 for presentation through a display device (e.g. television, monitor, projector, head-mounted display, laptop/tablet/mobile device screen, etc.).

The gameplay video 108 is fed to an AI recognition model 110 that analyzes the gameplay video and generates a description 114 of its content. More specifically, the AI recognition model 110 is configured to analyze image frames and/or image data of the gameplay video to recognize or determine various aspects of the contents of the gameplay video that provide a semantic understanding of gameplay activity occurring in the gameplay video, and generate a description of such aspects. By way of example without limitation, this can include recognition or determination of characters, objects, entities, actions, movements, locations, scenes, enemies, friends, teammates, mechanics, abilities, states, settings, inventories, resources, campaign/plot items, etc., or any other aspect of the video game that may be recognizable from the gameplay video and useful for describing or otherwise providing an understanding of the gameplay depicted in the gameplay video.

In some implementations, the AI recognition model 110 further receives the input data 106 that is also used by the video game 100. For example, the running of the AI recognition model 110 may be occurring on the user's local device (e.g. computer or game console), and the input data 106 may also be generated at the user's local device (e.g. through activation of a controller input device operatively connected to the user's local device) and is therefore readily available to the AI recognition model 110. By way of example without limitation, such input data 106 might include button presses, joystick movements, etc. which are correlated in time to the image frames of the gameplay video 108. The input data 106 thus can provide an additional source of information for the AI recognition model 110 to improve the recognition of gameplay activity.

In some implementations, the AI recognition model 110 is specifically configured to recognize activity of the particular video game, or a portion thereof, such as a particular level or section of the video game. In some implementations, the AI recognition model 110 is specifically trained on training data consisting of video of gameplay of the particular video game that has been labeled for recognition and descriptive generation purposes. In some implementations, the AI recognition model 110 is selected from a library of AI recognition models, including various models specifically configured to recognize activity of various video games or portions thereof.

In some implementations, the description 114 of gameplay generated by the AI recognition model 110 can be in the form of text data or other types of data. In some implementations, the AI-generated description 114 can be stored in the form of a text file. In some implementations, the AI-generated description 114 includes descriptive data that is timestamped, so as to provide descriptions which are correlated to the timing of events as they occur in the gameplay video.

In some implementations, the video game 100 further includes game instrumentation 104 that is configured to output a certain portion of instrumented game state data generated by the executing video game 100. However, in contrast to prior instrumented game systems, the game instrumentation 104 is configured to send a much more limited amount of game state data, that is significantly reduced in terms of the types of data and/or the rate or frequency at which such data is sent. The instrumented game state data is used by a verification process 112 to verify the accuracy of the description 114 of the gameplay video generated by the AI recognition model. It will be appreciated that the instrumented game state data reflects the canonical state of the video game, and accordingly, the verification process 112 is configured to determine whether the AI-generated description 114 of the gameplay video sufficiently matches the canonical state as revealed by the instrumented game state data. In various implementations, this determination can be performed at periodic intervals, or when certain instrumented game state data is received by the verification process 112.

It will be appreciated that by applying verification process 112 as described, an accurate description of the contents of the gameplay video can be more efficiently obtained. For whereas a prior process may have required processing of a dense stream of events from a large amount of instrumented game state data generated at high frequency (e.g. 60 times per second), the AI-generated description can be obtained from analyzing already existing gameplay video and periodically verified using significantly smaller amounts of instrumented game state data generated at much lower frequency (e.g. once per second) to ensure accuracy.

In some implementations, the results of the verification process 112 can be used as feedback to the AI recognition model 110 to further refine the model's recognition. For example, if the verification process 112 determines that the AI recognition model 110 did not sufficiently accurately describe a given portion of the gameplay video 108, then the corresponding instrumented game state data can be used to further train the AI recognition model 110 to correctly identify the contents of the gameplay video portion. In some implementations, the given portion of gameplay video can be flagged for manual follow-up, such as for manual labeling of the gameplay video portion and subsequent training of the AI recognition model 110.

It will be appreciated that in various implementations, the illustrated process can be executed locally by a local computing device (e.g. game console, personal computer, laptop, tablet, mobile device, etc.), or executed by a cloud system (e.g. cloud gaming system), or executed by a hybrid system in which execution is partially performed by a local system and partially by a cloud system. For example, in a cloud gaming implementation, the video game is executed by a cloud game machine to generate the gameplay video 108, and the gameplay video 108 is streamed over the Internet to the player's local device. In such an implementation, the local device can be configured to apply the AI recognition model 110 to the received gameplay video 108 to generate the description 114 locally. In some implementations, the AI-generated description 114 is uploaded to the cloud gaming system and stored in association with the user's account. In another implementation, the video game is executed on the user's local device to generate the gameplay video 108, and at least a portion of the gameplay video is uploaded to a cloud system which applies the AI recognition model 110 to the uploaded gameplay video in the cloud.

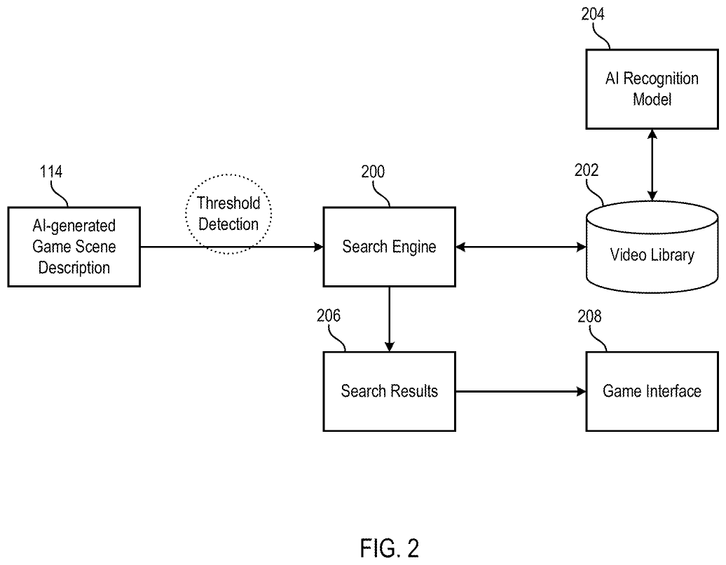

FIG. 2 illustrates a process for using an AI-generated description of gameplay to surface related videos, in accordance with implementations of the disclosure.

It will be appreciated that the AI-generated description 114 of the content of the gameplay video as described above, can be utilized for various purposes, including to surface relevant additional content to the user. For example, in some implementations, the AI-generated description 114, or a portion thereof, is used by a search engine 200 to search a video library 202 containing other gameplay videos of the video game. More specifically, the search engine 200 can be configured to search for gameplay videos in the video library 202 having similar elements or context to that of the user's gameplay video 108 from which the description 114 was generated. In this manner, videos depicting similar gameplay to that of the user's gameplay video 108 can be found and surfaced to the user. For example, such videos can be similar to the user's gameplay video 108 in terms of location or scene of the video game, characters, enemies, actions, or any other contextual item or activity. In some implementations, such videos are surfaced as search results 206 presented through a game interface 208 in association with the presentation of the video game to the user. The user can trigger playback of a selected one of the surfaced videos to view gameplay having similar context as the user's current gameplay.

It will be appreciated that such functionality can be useful for the user that may be experiencing difficulty in their gameplay of a particular section of the video game. By retrieving videos of similar gameplay in this manner, the user may easily find and view relevant videos that, for example, show gameplay by others of the same section of the video game (or a similar situation), and viewing such videos may show the user how to overcome the challenges of their current gameplay. Furthermore, as the AI recognition and description of the user's gameplay video can be very detailed and specific, so the retrieved videos can be very granularly relevant to the user. For example, retrieved videos may not only be specific to the user's overall situation, such as gameplay depicting the same boss fight or virtual location as that of the user, but may also share additional specific contextual details such as depicting gameplay using the same or a similar character, weapon, objects, abilities, skill level, etc.

In some implementations, an AI recognition model 204 has been used to analyze the videos of the video library 202, to generate descriptions/tags of the content of the videos that are timestamped or otherwise correlated to timepoints in the videos, to enable the search functionality. In some implementations, the AI recognition model 204 is similar or substantially the same as the AI recognition model 110. In some implementations, the search engine 200 carries out searches by matching terms of the description 114 against the descriptions/tags of the various videos of the video library 202. It will be appreciated that as the descriptions include information correlated to timepoints in the videos of the video library, so the search engine can identify not only a given video, but more specifically a portion of the given video to surface to the user, for example, denoted by identified start and end times based on the timestamped descriptions/tags.

In some implementations, the search engine 200 is manually accessed by the user through the game interface 208, which can be a platform level interface or game-specific interface in various implementations. In other implementations, the search engine 200 can be automatically triggered to search for contextually similar gameplay videos based on a threshold detection process. For example, the search may be triggered when the AI-generated game description 114 indicates that the user is struggling or otherwise having difficulty in advancing in their gameplay. In some implementations, when it is detected that the user is struggling, then the user is prompted with a suggestion to search/view related videos, and if the user indicates they would like to view related videos, then the search is triggered.

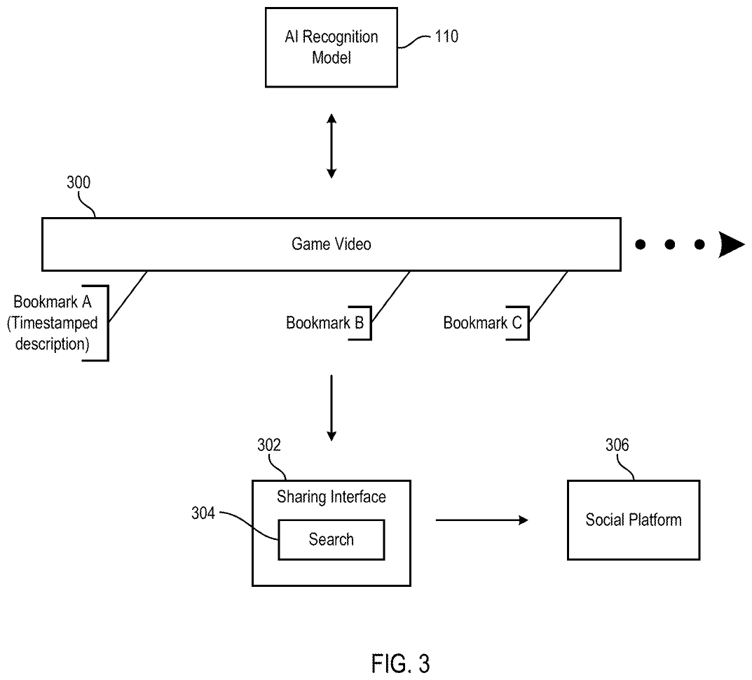

FIG. 3 conceptually illustrates bookmarking of gameplay video and sharing of bookmarked sections, in accordance with implementations of the disclosure.

It will be appreciated that the AI-generated descriptions can be used for various purposes, including sharing of video, such as to a social network. In the illustrated implementation, the gameplay video 300 is analyzed using the AI recognition model 110, and the AI-generated description of the gameplay video 300 is used to generate various timestamped bookmarks, such as Bookmark A, B, and C in the illustrated implementation. Each of the timestamped bookmarks can include descriptive information pertaining to the segment of video that begins at the timestamped location of that bookmark.

In some implementations, these bookmarks can be used to facilitate sharing of the gameplay video, or a portion thereof. In some implementations, a sharing interface 302 is presented to the user, which can be presented in-game or after gameplay has been completed. The sharing interface 302 can include a search feature 304 enabling the user to search for specific items in the gameplay video 300, by searching the descriptive information of the bookmarks. Based on the results, the user may select a given bookmark, and share the bookmark of the video to a social platform 306, such as a social network, a social communications platform, etc. In some implementations, sharing of the bookmark includes sharing a web link that accesses the bookmarked video. When a receiving user accesses the bookmark, then they automatically begin playback of the video at the bookmarked location.

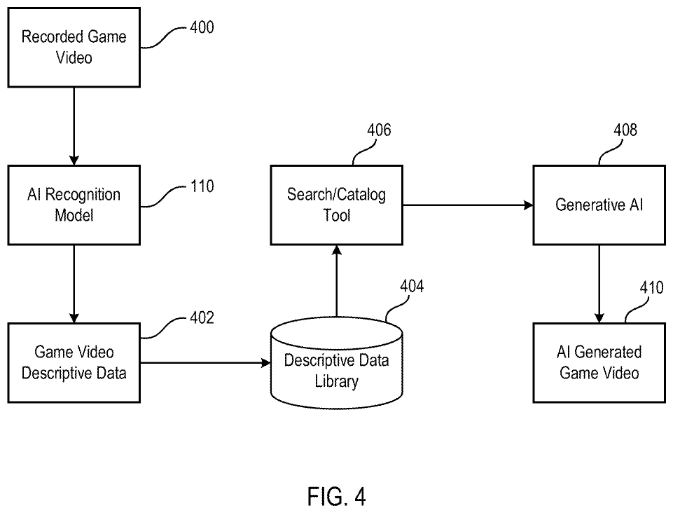

FIG. 4 conceptually illustrates a process for re-generating a gameplay video that is configured to be similar to an original gameplay video, in accordance with implementations of the disclosure.

A recorded gameplay video 400 is fed to the AI recognition model 110, which generates game video descriptive data 410 which describes the contents of the recorded gameplay video 400, including descriptions of objects and events depicted in the recorded gameplay video 400 in accordance with the principles of the present disclosure. It will be appreciated that the AI-generated game video descriptive data 410 can be significantly smaller than the data amount of the recorded gameplay video 400. For the AI-generated descriptions of objects and events can be significantly smaller than the amount of the video data required to depict such objects and events. For example, a representation of an object such as a character in the recorded gameplay video 400 may require a large number of pixel values, whereas the character can be represented in the game video descriptive data 410 simply by referencing an identifier or name of the character, which requires much less data. The difference in data requirements can be even more dramatic for events, as an event's depiction in video data may require pixel values over many frames of video, whereas the same event could be described by the AI recognition model 110 using a few words or the equivalent. While these are simplified examples demonstrating the concept, it will be appreciated that an AI-generated description of video can require far less data than the video itself, yet contain the equivalent semantic information as the video.

Thus, by employing the AI recognition model 110 to generate the game video descriptive data 402 in this manner, a light-weight version of the user's gameplay video is created, which can be stored to a descriptive data library 404. The descriptive data library 404 can thus store the specific game video descriptive data 402, as well as other descriptions of other gameplay videos, for the instant user as well as other users in various implementations, thus forming a repository of semantic descriptions of users' gameplays.

In some implementations, the game video descriptive data 402 is stored in the form of a text file or other data file format. In some implementations, the descriptive data 402 includes words, numbers, punctuation, symbols, etc. In some implementations, the descriptive data 402 includes human-comprehensible language or non-human comprehensible language. In some implementations, the descriptive data 402 includes vector representations of objects or events.

Using the stored game video descriptive data 402, it is possible to regenerate the gameplay video. In some implementations, a search/catalog tool 406 is provided, which provides an interface for searching or otherwise accessing the various stored descriptive data of the descriptive data library 404. For example, the search/catalog tool 406 may enable searching or filtering to access specific video descriptive data based on criteria such as the game title, objects, events, specific user, etc. A given descriptive data file can be selected and retrieved from the library 404, and a generative AI 408 can be applied to the selected descriptive data file to generate AI-generated game video 410.

The generative AI 408 is configured to generate the game video 410 based on the descriptive data file so as to be substantially similar or substantially the same as the original gameplay video, such as gameplay video 400 in the case of using the descriptive data 402 to generate the game video 410. Accordingly, it will be appreciated that the generative AI 408 is configured to generate video depicting gameplay based on descriptive data. For example, while the AI recognition model 110 may be trained on labeled video as has been described, in some implementations, the generative AI 408 can be trained using the same or similar training data, but in a reversed process wherein the generative AI 408 is trained to generate the video based on the labels/descriptors. In some implementations, the generative AI 408 is specific to a given video game, and trained to generate gameplay video for that specific video game only.

In this manner, a “replay” video that is at least similar to the original gameplay video can be generated and presented to a user, while avoiding the need for extensive storage capability that would normally be required to enable such a replay video to be presented. This dramatically reduces the amount of storage required for a given users' gameplay video history, to the point where it becomes possible to store a given users' entire gameplay video history either locally or by a cloud system. In some implementations, the generative AI 408 can be run on a cloud resource, and the AI-generated video streamed over the Internet to a given user. In other implementations, the generative AI 408 can be run on a user's local device, and only the descriptive data transmitted from a cloud storage over the Internet to the user's local device. This further reduces the network resources required to enable replay videos to be shared.

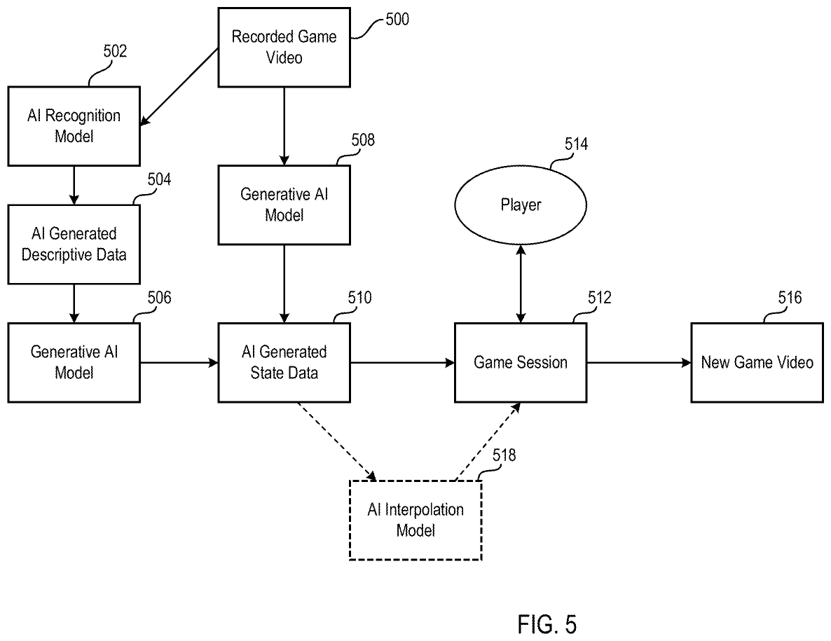

FIG. 5 conceptually illustrates a process for using generative AI to recreate game state data capable of being run by an instance of a video game, in accordance with implementations of the disclosure.

In the illustrated implementation, recorded gameplay video 500 from a first session of a video game is provided. An AI recognition model 502 is applied to the gameplay video 500 to generate descriptive data 504, in accordance with principles of the present disclosure as have been described. In order to recreate the gameplay of the gameplay video 500, a generative AI 506 is configured to generate game state data 510 using the descriptive data 504. The AI-generated game state data 510 is then processed by a second session 512 of the video game, so that the second session 512 renders new gameplay video 516 that is substantially similar or substantially the same as the original recorded gameplay video 500.

In an alternative implementation, a generative AI model 508 directly generates the game state data 510 from the recorded gameplay video 500, as opposed to the above-described process involving generation of descriptive data 504 first. In a sense, the generative AI model 508 is configured to perform the reverse of normal game video rendering, by generating game state data based on already rendered gameplay video, whereas ordinarily the gameplay video is rendered based on the game state data.

It will be appreciated that the game state data 510 is AI-generated so as to be compatible with the syntax, format and conventions of the video game's execution, so as to be suitable for processing by the session 512 in substantially the same way that game state data generated during regular gameplay is processed. In some implementations, generating the game state data 510 includes inferring inputs, such as controller inputs or other input data generated in response to user interactive activity, which are applied by the second session 512 of the video game. In some implementations, the generative AI model 506 or 508 is configured to generate game state data for the specific video game, and may be trained using descriptive data or gameplay video, and corresponding game state data. In some implementations, the AI-generated game state data can be substantially similar or substantially the same as the game state data that was originally generated by the first session of the video game. By applying the AI-generated game state data for processing by the session 512, the session 512 can be configured to re-render a substantially similar gameplay video, or portion thereof, to the original gameplay video 500 of the original session.

In some implementations, the AI-generated game state data 510 is generated at a rate that is less than the native rate of processing by the session 512 of the video game, and therefore an AI interpolation model 518 is applied to interpolate the AI-generated game state data 510 to provide additional game state data in order to provide the full amount of game state data necessary to fulfill the processing requirement of the session 512.

In some implementations, the AI-generated game state data 510, or a portion thereof, can be utilized to enable a player 514 to engage in gameplay of substantially the same game scene or situation that was depicted in the recorded gameplay video 500, including with the same conditions such as using the same character, objects, abilities, etc. It will be appreciated that player 514 can be the same player that originally generated the recorded gameplay video 500 through gameplay of the original game session, thus allowing the player to retry gameplay of a previously played game scene. Or the player 514 can be a different player that is now enabled to attempt playing the same scene under the same conditions as the original player. The AI-generated game state data 510 can be used to set up the game state of the game session 512 at a certain point in the gameplay video 500, and the player 514 then enabled to take control of the gameplay progressing from that point forward. In some implementations, the game state data 510, which can include inferred input data as noted above, is used for re-rendering of the gameplay video 516 for presentation to the player 514, and the player 514 may select an option to trigger gameplay at a certain point in the playback, at which point the execution of the game session 512 switches to being driven by inputs controlled by the player 514, such as inputs received from a controller device operated by the player 514.

It will be appreciated that existing mechanisms for enabling a player to retry gameplay of a previously played game scene require recording of game state data or user save data at the time of gameplay. Existing games may enable a player to save their game, or perform autosaves periodically or at predefined game campaign points. However, this not only requires saving data at the time of gameplay while it still exists in memory of the game hardware system, but is necessarily limited to only those selected time points when game saves actually occur. However, in the present implementation, no such limitations exist, as the game state data for any point in time in the gameplay video can be inferred using generative AI, possibly via an intermediary process involving AI-generated descriptive data as has been described. Thus, even without game saves performed at the time of gameplay, it is possible based on the gameplay video alone, to situate a player to engage in gameplay of the same situation as is depicted at any point in time in the gameplay video.

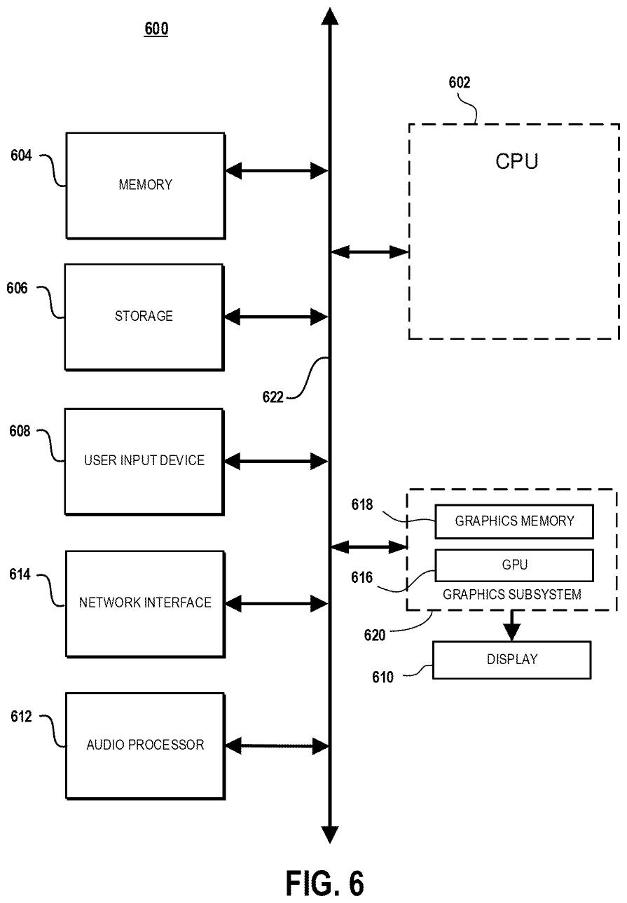

FIG. 6 illustrates components of an example device 600 that can be used to perform aspects of the various embodiments of the present disclosure. This block diagram illustrates a device 600 that can incorporate or can be a personal computer, video game console, personal digital assistant, a server or other digital device, suitable for practicing an embodiment of the disclosure. Device 600 includes a central processing unit (CPU) 602 for running software applications and optionally an operating system. CPU 602 may be comprised of one or more homogeneous or heterogeneous processing cores. For example, CPU 602 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 600 may be a localized to a player playing a game segment (e.g., game console), or remote from the player (e.g., back-end server processor), or one of many servers using virtualization in a game cloud system for remote streaming of gameplay to clients.

Memory 604 stores applications and data for use by the CPU 602. Storage 606 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the internet. An audio processor 612 is adapted to generate analog or digital audio output from instructions and/or data provided by the CPU 602, memory 604, and/or storage 606. The components of device 600, including CPU 602, memory 604, data storage 606, user input devices 608, network interface 610, and audio processor 612 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Graphics memory 618 can be integrated in the same device as GPU 608, connected as a separate device with GPU 616, and/or implemented within memory 604. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs.

The graphics subsystem 614 periodically outputs pixel data for an image from graphics memory 618 to be displayed on display device 610. Display device 610 can be any device capable of displaying visual information in response to a signal from the device 600, including CRT, LCD, plasma, and OLED displays. Device 600 can provide the display device 610 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method implemented by at least one computing device for providing verified recognition for a video game, comprising:
executing a session of a video game, wherein the execution of the session generates gameplay video, and wherein the execution of the session further includes execution of instrumentation of the video game that outputs game event data;
using an artificial intelligence (AI) recognition model to analyze the gameplay video and generate an AI-generated description of gameplay events occurring in the gameplay video;
using the game event data to verify the AI-generated description;
storing the verified AI-generated description to a storage device.

2. The method of claim 1, wherein using the AI recognition model to analyze the gameplay video and using the game event data to verify the AI-generated description occurs in substantial real-time concurrent with the execution of the session of the video game.

3. The method of claim 1, wherein using the game event data to verify the AI-generated description includes determining a similarity between the AI-generated description and the game event data for corresponding timepoints within the gameplay video.

4. The method of claim 3, wherein determining the similarity uses a similarity model that maps terms generated by the instrumentation to terms generated by the AI recognition model.

5. The method of claim 1, wherein the game event data identifies one or more of characters, objects, actions, movements, locations, scenes, and settings of the video game.

6. The method of claim 1, wherein the AI-generated description consists of text data.

7. The method of claim 1, further comprising:
using the verified AI-generated description to search a library of pre-recorded gameplay videos;
surfacing through a user interface during the execution of the video game, one or more of the pre-recorded gameplay videos identified by the search.

8. The method of claim 1, further comprising:
retrieving the AI-generated description from the storage device;
using a generative AI model to generate a replay video based on the AI-generated description;
presenting the replay video on a display device.

9. The method of claim 1, further comprising:
retrieving the AI-generated description from the storage device;
using a generative AI model to generate state data based on the AI-generated description;
applying the state data to execute a second session of the video game, so that the execution of the second session is configured to generate a replay video that is similar to the gameplay video.

10. The method of claim 9, wherein the execution of the second session is further configured to receive player input to drive the execution of the second session, enabling interactive gameplay of a scene depicted in the gameplay video.

11. A non-transitory computer-readable medium having program instructions embodied thereon that, when executed by at least one computing device, cause said at least one computing device to perform a method including the following operations:
executing a session of a video game, wherein the execution of the session generates gameplay video, and wherein the execution of the session further includes execution of instrumentation of the video game that outputs game event data;
using an artificial intelligence (AI) recognition model to analyze the gameplay video and generate an AI-generated description of gameplay events occurring in the gameplay video;
using the game event data to verify the AI-generated description;
storing the verified AI-generated description to a storage device.

12. The non-transitory computer-readable medium of claim 11, wherein using the AI recognition model to analyze the gameplay video and using the game event data to verify the AI-generated description occurs in substantial real-time concurrent with the execution of the session of the video game.

13. The non-transitory computer-readable medium of claim 11, wherein using the game event data to verify the AI-generated description includes determining a similarity between the AI-generated description and the game event data for corresponding timepoints within the gameplay video.

14. The non-transitory computer-readable medium of claim 13, wherein determining the similarity uses a similarity model that maps terms generated by the instrumentation to terms generated by the AI recognition model.

15. The non-transitory computer-readable medium of claim 11, wherein the game event data identifies one or more of characters, objects, actions, movements, locations, scenes, and settings of the video game.

16. The non-transitory computer-readable medium of claim 11, wherein the AI-generated description consists of text data.

17. The non-transitory computer-readable medium of claim 11, wherein the method further includes:
using the verified AI-generated description to search a library of pre-recorded gameplay videos;
surfacing through a user interface during the execution of the video game, one or more of the pre-recorded gameplay videos identified by the search.

18. The non-transitory computer-readable medium of claim 11, wherein the method further includes:
retrieving the AI-generated description from the storage device;
using a generative AI model to generate a replay video based on the AI-generated description;
presenting the replay video on a display device.

19. The non-transitory computer-readable medium of claim 11, wherein the method further includes:
retrieving the AI-generated description from the storage device;
using a generative AI model to generate state data based on the AI-generated description;
applying the state data to execute a second session of the video game, so that the execution of the second session is configured to generate a replay video that is similar to the gameplay video.

20. The non-transitory computer-readable medium of claim 19, wherein the execution of the second session is further configured to receive player input to drive the execution of the second session, enabling interactive gameplay of a scene depicted in the gameplay video.
